(19) United States
(12) Patent Application Publication
(10) Pub. No.: US 2008/0192998 A1
(43) Pub. Date: Aug. 14, 2008

(54) IMAGE PROCESSING APPARATUS AND IMAGE PROCESSING METHOD

(75) Inventors: Tomoyuki Takeguchi, Kawasaki-shi (JP); Masahide Nishiura, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/028,954

(22) Filed: Feb. 11, 2008

(30) Foreign Application Priority Data
Feb. 13, 2007 (JP) P2007-032755

(51) Int. Cl. G06K 9/00

(52) U.S. Cl. 382/128

(57) ABSTRACT

An image processing apparatus includes: an image inputting unit configured to acquire an image of an organ having a cavity; a filtering unit configured to filter the image by applying a spatial filter to the image, the spatial filter emphasizing a pixel information of the image at a center position of a closed area corresponding to the cavity; a center estimating unit configured to estimate the center position of the cavity from the filtered image; and a boundary determining unit configured to determine a boundary line corresponding to a wall of the cavity based on the filtered image and the estimated center position.

### CROSS-REFERENCE TO RELATED APPLICATIONS

This application is based upon and claims the benefit of priority from Japanese Patent Application No. 2007-032755, filed Feb. 13, 2007, the entire contents of which are incorporated herein by reference.

### BACKGROUND OF THE INVENTION

1. Field

The present invention relates to an image processing apparatus for estimating automatically a profile of a cavity from an image of an internal organ having a cavity therein, and an image processing method for estimating automatically a profile of a cavity from an image of an internal organ having a cavity therein.

2. Related Art

JP-A-8-336503(KOKAI) discloses a method of obtaining a profile of a subject of interest by binarizing a region of interest (ROI) containing the subject of interest in the image. However, such a problem existed that the region of interest must be pointed manually.

JP-A-10-229979 (KOKAI) discloses a method of estimating the outer wall boundary of the cardiac muscles by using an active contour model, based on the inner wall boundary of the cardiac muscles. However, such a problem existed that the inner wall boundary must be detected by any other way.

Japanese Patent No. 3194741 discloses a method of deriving the curved boundary by detecting a center point of the diagnostic image and then applying an elliptic arc model to this center point. However, such a problem existed that, because such center is detected directly from the diagnostic image, it is difficult to detect the center point.

As described above, in order to estimate the boundary between the inner and outer walls of the cardiac muscles, any initial value is needed, any operation is required of the operator of the diagnostic equipment, or the diagnostic image is directly used. Therefore, there was the case that it is difficult to detect the boundary.

### SUMMARY OF THE INVENTION

According to one embodiment of the present invention, there is provided an image processing apparatus including: an image inputting unit configured to acquire an image of an organ having a cavity; a filtering unit configured to filter the image by applying a spatial filter to the image, the spatial filter emphasizing a pixel information of the image at a center position of a closed area corresponding to the cavity; a center estimating unit configured to estimate the center position of the cavity from the filtered image; and a boundary determining unit configured to determine a boundary line corresponding to a wall of the cavity based on the filtered image and the estimated center position.

According to another embodiment of the present invention, there is provided an image processing method comprising: acquiring an image of an organ having a cavity; filtering the image by applying a spatial filter to the image, the spatial filter emphasizing a pixel information of the image at a center position of a closed area corresponding to the cavity; estimating the center position of the cavity from the filtered image; and determining a boundary line corresponding to a wall of the cavity based on the filtered image and the estimated center position.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of an image processing apparatus according to a first embodiment.

FIG. 2 is a flowchart showing an operation of the first embodiment.

FIG. 3 is a schematic drawing of a parasternal short axis view obtained by the ultrasound diagnostic equipment.

FIG. 4 is a view showing a profile of a Laplacian-Of-Gaussian filter.

FIG. 5 is a view showing a model geometry applied as an initial profile and an energy function used in estimation.

FIG. 6 is a block diagram showing a configuration of an image processing apparatus according to a second embodiment.

FIG. 7 is a flowchart showing an operation of the second embodiment of the present invention.

### DETAILED DESCRIPTION OF THE INVENTION

An image processing apparatus according to embodiments of the present invention will be explained with reference to the drawings hereinafter.

### First Embodiment

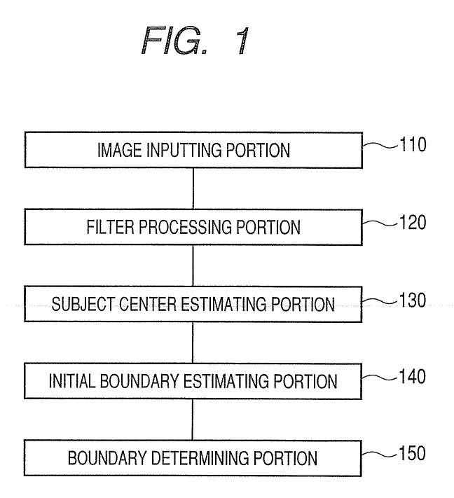

An image processing apparatus according to a first embodiment of the present invention will be explained with reference to FIG. 1 to FIG. 5 hereunder. In the present embodiment, in an example that the heart is selected as the object organ, the case where a boundary of cardiac muscles of a left ventricle as a cavity portion is estimated by selecting the left ventricle as a subject of interest will be explained hereunder.

(1) Configuration of Image Processing Apparatus

FIG. 1 is a block diagram showing an image processing apparatus according to the present embodiment.

The image processing apparatus has an image inputting portion 110 for acquiring a sectional image of the heart, a filter processing portion 120 for acquiring an output image by applying a spatial filter to the sectional image, a subject center estimating portion 130 for estimating a subject center from the output image, an initial boundary estimating portion 140 for estimating an initial boundary of a cavity portion by using the estimated subject center and the output image, and a boundary determining portion 150 for deciding the final boundary by using the obtained initial boundary as an initial value.

(2) Operation of Image Processing Apparatus

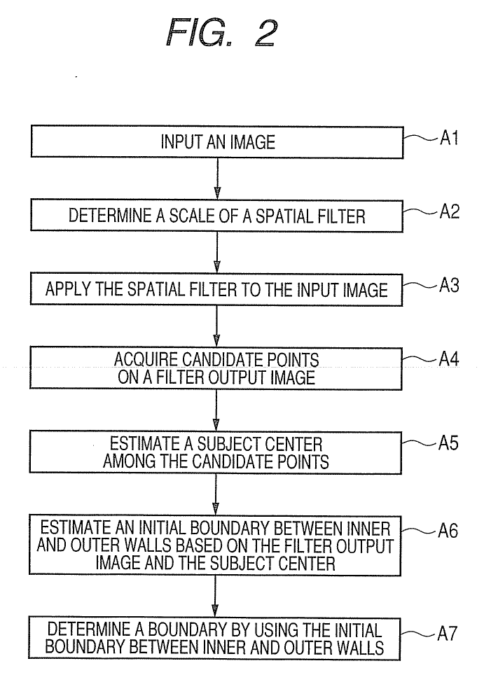

Next, an operation of the image processing apparatus according to the present embodiment will be explained with reference to FIG. 1 and FIG. 2 hereunder. Here, FIG. 2 is a flowchart showing an operation of the image processing apparatus according to the present embodiment.

(2-1) Image Inputting Portion 110

The image inputting portion 110 acquires the sectional image containing the cavity portion (see step A1).

For example, the two-dimensional sectional image of the heart is taken herein by using the ultrasound diagnostic equipment. The sectional image is different depending upon a position and an angle of the probe. Herein, as recited in Non-Patent Literature 4 (“ABC of echocardiography”, edited by the Japan Medical Association, pp. 6-7, Nakayama Shoten, 1995), a parasternal short axis view of the heart will be explained as an example. This short axis image is obtained at a papillary muscle level by approaching the subject who lies one his or her side with facing halfway to the left from an area between the 3-rd and 4-th ribs at the left edge of the sternum.

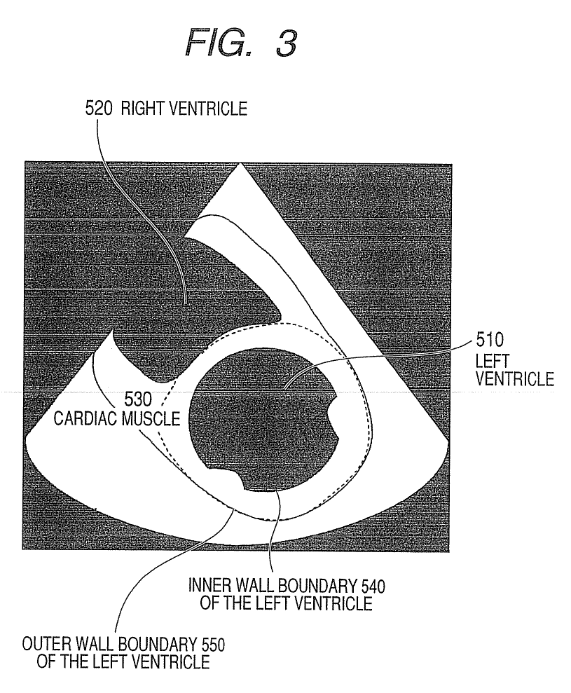

A schematic view of the left ventricle sectional image at a papillary muscle level is shown in FIG. 3. Also, in addition to a left ventricle 510 as the cavity portion, a right ventricle 520 and a cardiac muscle 530 are shot in the sectional image.

(2-2) Filter Processing Portion 120

Next, a spatial filtering is applied to the sectional image by the filter processing portion 120.

As shown in FIG. 3, in the short axis sectional image, the inner area of the left ventricle 510 has a relatively low brightness and a roughly circular shape, and the cardiac muscle portion has a relatively high brightness. Therefore, as the spatial filter that can compares the brightness between two areas, a Laplacian-Of-Gaussian (LOG) filter set forth in Non-Patent Literature 1 (Tony Lindeberg, “Feature Detection with Automatic Scale Selection”, International Journal of Computer Vision, Vol. 30, No. 2, pp. 79-116, 1998) is employed. A formula of the Laplacian-Of-Gaussian filter is given by Equation (1).

[Formula 1]

F(x,y)=σ²×L*G(σ)*I(x,y) (1)

Where, I(x,y) is an input sectional image, G(σ) is a two-dimensional Gaussian filter, L is a two-dimensional Laplacian filter, * is a symbol showing a convolution integration, F(x,y) an output image, and C is a parameter representing an amount of blur of the Gaussian filter.

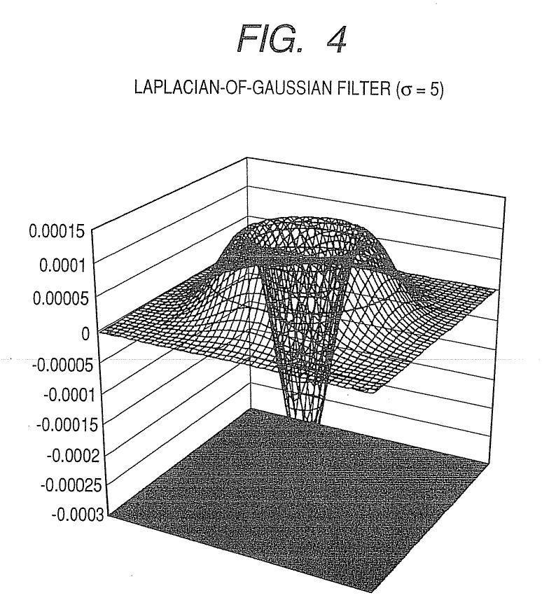

The two-dimensional Laplacian-Of-Gaussian filter is a filter having a profile shown in FIG. 4. The image is calculated by a difference of weighted brightness values between two areas of an area having the object pixel at a center and the peripheral area.

The parameter σ is a scale parameter adjusting a scale of the spatial filter, and a size of the compared areas can be adjusted by σ. Then, an absolute value of the output of the Laplacian-Of-Gaussian filter is increased when a difference between two areas is large. That is, when an adequate scale parameter σ is set, a center portion of the left ventricle and the peripheral cardiac muscle portion are compared with each other and the output is increased. When a size of the heart, a thickness of the cardiac muscles, and the like can be estimated based on the preliminary knowledge, the scale parameter σ as the optimum size to estimate the center of the left ventricle is determined in advance (see step A2). In this case, when the scale parameters σ cannot be determined uniquely, a plurality of scale parameters σ may be prepared.

Then, the output image processed by applying the spatial filtering to the input image by the Laplacian-Of-Gaussian filter using a predetermined scale parameter σ is obtained (see step A3). When a plurality of scale parameters σ are set, a plurality of output images are obtained by each scale parameter respectively.

Here, any spatial filter may be employed if compared results of the brightness in two areas can be output. For example, the similar effect can be achieved by employing a differential Gaussian filter (Difference Of Gaussian: DOG) set forth in Non-Patent Literature 2 (David G. Lowe, “Distinctive Image Features from Scale-Invariant Keypoints”, International Journal of Computer Vision, Vol. 60, No. 2, pp. 91-110, 2004), a separability filter set forth in Japanese Patent No. 3279913, or the like instead of the Laplacian-Of-Gaussian filter.

(2-3) Subject Center Estimating Portion 130

Next, a center position of the cavity portion as the subject of interest is estimated based on the obtained output image by the subject center estimating portion 130.

Since the brightness is low around the center of the left ventricle and the brightness is high in the cardiac muscles in the peripheral portion, the output of the Laplacian-Of-Gaussian filter when the adequate scale parameter σ is given is increased around the center of the left ventricle area. Therefore, a position at which the number of pixels is maximum is acquired as the center candidate of the cavity portions by comparing respective pixels of the output image around 8 pixels (see step A4). When a plurality of output images are present, a center candidate of the cavity portion is extracted from each output image respectively.

Then, a center of the cavity portion is determined among the center candidates of the obtained cavity portions (see step A5). Here, the candidate point at which a value consisting of a weighted sum of two values of a value of the output image at the center candidate of the obtained cavity portion and a distance from the center position of the output image is at a maximum is selected as the center position. An appropriate value is detected in advance experimentally as a weight factor of the weighted sum. In this case, the reason why the center position of the output image is used as the weighted sum is that, when the doctor shots the left ventricle of the heart, normally such doctor sets a center of the image and a center position of the left ventricle coincide with each other or tries to coincide them with each other. Accordingly, it is possible to exclude the center candidates near the edge portions of the image.

(2-4) Initial Boundary Estimating Portion 140

Next, an initial value of the boundary between inner and outer wall surfaces of the cardiac muscles of the left ventricle is estimated by the initial boundary estimating portion 140 by using the determined center position and the output image being subjected to the filtering process. An energy function in deciding the inner wall is given by Equation (1), and an energy function in deciding the outer wall is given by Equation (2).

[Formula 2]

E(\vec{c},r)=∫_{θ}(F(\vec{c},θ,r)²dθ (2)

E(\vec{c},r)=∫_{θ}(F(\vec{c},θ,r)−Fₘᵢₙ)²dθ (3)

Where c is an estimated subject center, r is a radius of a circle around the center c, and Fₘᵢₙ is a minimum value of the output image.

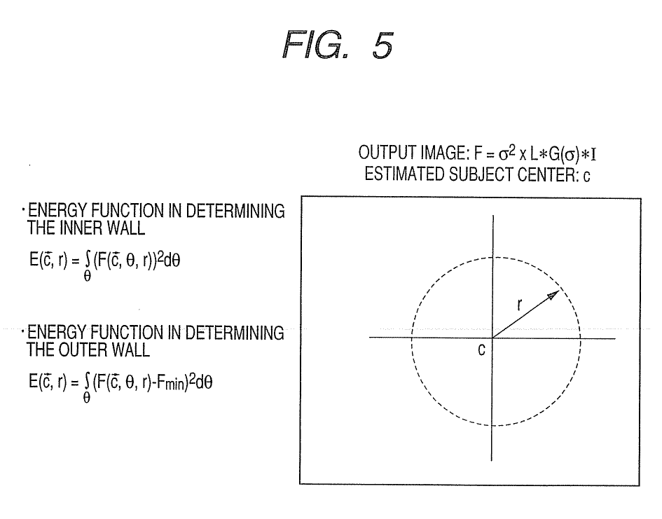

As shown in FIG. 5, the energy calculated by a line integral of a circular portion with a radius r around the estimated subject center by utilizing the output image is defined, and r is determined to make the defined energy of the inner and outer walls minimum (see step A6).

Here, when a plurality of output images are present, the energy may be calculated by using an average output image that is obtained by calculating a weighted sum of all output images, or may be calculated by using the output image whose center position is selected as a representation.

(2-5) Boundary Determining Portion 150

Finally, a final boundary position is determined by using the initial boundary position by the boundary determining portion 150 (see step A7).

Here, a active contour model set forth in Non-Patent Literature 3 (M. Kass, A. Witkin and D. Terzopoulos, “Snakes: Active Contour Models”, International Journal of Computer Vision, 1, pp. 321-331, 1988) is employed.

The profile extracted result by using the active contour model is largely affected by the initial value. However, the stable boundary extraction can be carried out by utilizing a profile position obtained by the present embodiment as the initial boundary. Also, the existing approach other than the active contour model referred to herein can be utilized. For example, a profile extracting method set forth in Japanese Patent No. 3468869 can be applied.

(3) Advantage

In this manner, according to the image processing apparatus according to the first embodiment, the center position of the cavity portion is estimated from the output image obtained by applying the filtering process to the input image, the energy function necessary for the initial profile estimation is defined by using the output image utilized in the center estimation, the initial boundary is acquired by deforming the circular shape around the obtained center position, and the active contour model using the obtained initial boundary as the initial value is applied. As a result, the final boundary extraction can be carried out automatically.

### Second Embodiment

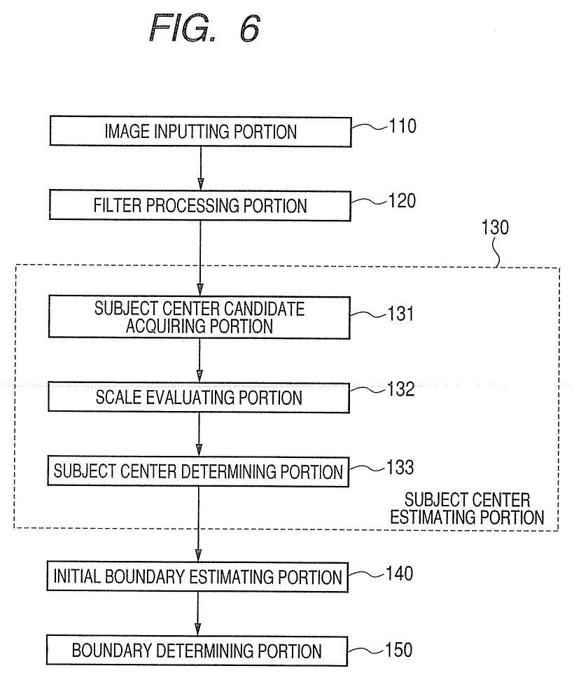

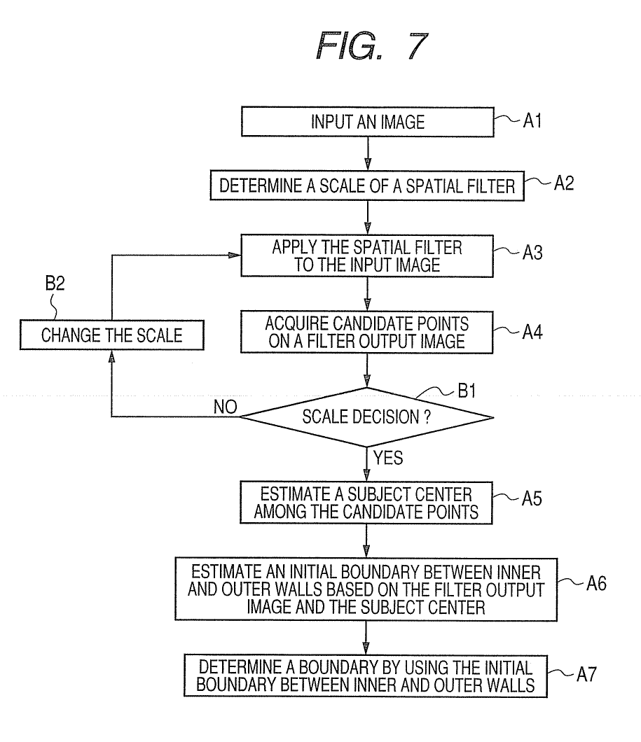

Next, an image processing apparatus according to a second embodiment of the present invention will be explained with reference to FIG. 6 and FIG. 7 hereunder.

(1) Feature of the Present Embodiment

In the first embodiment, the subject center candidates are extracted from one output image of more obtained by applying the filtering process to the input image. In this method, when a plurality of scale parameters σ are set in the filtering process, a plurality of output image are derived and thus the number of candidate points is increased because the subject center candidate is extracted from each output image respectively. It is more difficult to select the correct center position as the number of candidate points is increased larger. Also, the boundary estimation can be done stably when the output image obtained by the adequate scale parameter Cy is employed in the initial boundary estimation. Therefore, if the adequate scale parameter σ is determined prior to a decision of the center position, the failure of the subject center estimation can be reduced and an accuracy of the initial boundary estimation can be improved.

Therefore, as shown in a block diagram of FIG. 6, in the image processing apparatus according to the present embodiment, instead of the subject center estimating portion 130 in the first embodiment, a subject center candidate acquiring portion 131 for acquiring the subject center candidate from the output image being subject to the filtering process, a scale evaluating portion 132 for selecting the output image optimum to the center estimation based on the output image and the center candidate, and a subject center deciding portion 133 for selecting a center from the center candidates obtained from the output image that is determined as the optimum by the scale evaluating portion 132 are provided.

(2) Operation of Image Processing Apparatus

Next, an operation of the image processing apparatus according to the present embodiment will be explained with reference to FIG. 6 and FIG. 7 hereunder. FIG. 7 is a flowchart showing an operation of the image processing apparatus according to the present embodiment.

The image containing the cavity portion is acquired by the image inputting portion 110. Like the first embodiment, the parasternal short axis image at a papillary muscle level will be explained as an example hereunder (see step A1 in FIG. 7).

Then, the spatial filtering is applied to the input image by the filter processing portion 120. The Laplacian-Of-Gaussian filter is employed as the spatial filter. In this case, the scale parameter σ is determined in advance to an adequate initial value experimentally (see step A2).

Then, the output image obtained by processing the input image by the Laplacian-Of-Gaussian filter using the initial value or the changed scale parameter σ is obtained (see step A3).

Then, the center position of the subject is estimated based on the obtained output image by the subject center candidate acquiring portion 131. A position at which the number of pixels is maximum is acquired as the center candidate by comparing respective pixels of the output image around 8 pixels (see step A4)

Then, it is determined by the scale evaluating portion 132 whether or not the scale parameter σ is adequate, based on the number of center candidates obtained by the subject center candidate acquiring portion 131.

This decision is made on the assumption that the cavity portion to be shot is the left ventricle, a large mass of pixels having a low brightness is depicted near the center of the image, and a small number of pixels having a low brightness (e.g., the left atrium and edge portions of the image out of the shooting range) is also present on the outside of the left ventricle.

In order to take a view of a broad configuration of such image, it is desirable to give a somewhat large scale parameter σ. Therefore, the scale parameter σ given in step A2 is increased until this parameter satisfies the condition.

Concretely, when the number of center candidates is in excess of the predetermined number, it is determined that the scale parameter σ is excessively small and then the process goes to step B2. When the number of center candidates is less than the predetermined number, it is determined that the broad configuration can be obtained and then the process goes to step A5. Here, a threshold applied to determine the number of center candidates is determined in advance experimentally to an adequate value (see step B1).

Then, when the process goes to step B2, the scale parameter σ is predetermined times increased and then the process goes back to step A3. The change of the scale parameter and the extraction of the center candidate are repeated in the scale evaluating portion 132 until it is determined that the scale parameter σ is appropriate (see step B2).

Then, the center position is determined from the center candidates detected from the output image, which is obtained by using the scale parameter σ determined as the adequate one by the scale evaluating portion 132, by the subject center deciding portion 133. In this method, the candidate point at which a value consisting of a weighted sum of two values of a value of the output image at the obtained center candidate and a distance from the center position of the output image is at a maximum is selected as the subject center. An appropriate value is detected in advance experimentally as a weight factor of the weighted sum (see step A5).

Then, like the first embodiment, the initial boundary position is estimated by the boundary estimating portion 140, based on the output image determined as the optimum one by the scale evaluating portion 132 and the subject center obtained by the subject center deciding portion 133 (see step A6).

Finally, like the first embodiment, the boundary position is determined by the boundary determining portion 150 (see step A7).

(3) Advantage

In this manner, according to the image processing apparatus of the second embodiment, the scale parameter in the filtering process applied to the input image can be determines to the adequate value.

Also, the output image is acquired by the spatial filter having a predetermined scale parameter, the center position of the cavity portion is estimated from the obtained output image, the energy function necessary for the initial profile estimation is defined by using the output image utilized in the center estimation, the initial boundary is acquired, and the active contour model using the obtained initial boundary as the initial value is applied. As a result, the final boundary extraction can be carried out automatically.

(Variations)

Here, the present invention is not restricted to the embodiments as they are. The constituent elements can be deformed and embodied at the implementing stage in a range not departing from a gist of the invention. Also, various inventions can be created by combining appropriately a plurality of constituent elements disclosed in the embodiments. For example, several constituent elements may be deleted from all constituent elements disclosed in the embodiments. Also, the constituent elements may be combined appropriately over different embodiments.

(1) Variation 1

In the first embodiment, the case where the parasternal short axis view is input is explained. In addition, for example, the present invention can be applied to the case where the left ventricle is selected as the subject in the apical four chamber view. In this case, the parameters in the filter processing portion 120 and the subject center estimating portion 130 are changed adequately, and the model shape applied to the initial boundary estimating portion 140 is changed from a circular shape to an elliptic shape or an any curved shape.

(2) Variation 2

In the first embodiment, the method of employing the sectional image as the two-dimensional image is used as the input image is described. In addition, the present invention can be applied to the case where the input image is a three-dimensional image. In this case, a three-dimensional spatial filter is employed in the filter processing portion 120, a parameter in the subject center estimating portion 130 is changed appropriately, and the model shape applied to the initial boundary estimating portion 140 is a three-dimensional curved surface.

(3) Variation 3

In the above embodiments, the heart is explained as the internal organ. But the present invention is not restricted to this case. Any organ may be employed if the organ contains the cavity portion. For example, the blood vessel, the stomach, the uterus, and the like may be applied.

As described with reference to the embodiment, there is provided an image processing apparatus capable of estimating automatically a profile of a cavity from an image picked up from an internal organ having a cavity therein not to need the initial value being input by the manual operation.

What is claimed is:

1. An image processing apparatus comprising:
an image acquiring unit configured to acquire an image of an organ having a cavity;
a filtering unit configured to filter the image by applying a spatial filter to the image, the spatial filter emphasizing a pixel information of the image at a center position of a closed area corresponding to the cavity;
a center estimating unit configured to estimate the center position of the cavity from the filtered image; and
a boundary determining unit configured to determine a boundary line corresponding to a wall of the cavity based on the filtered image and the estimated center position.

2. The apparatus according to claim 1,
wherein the spatial filter detects a difference of a weighted sum of brightness between the closed area and a surrounding area of the closed area.

3. The apparatus according to claim 1, wherein the spatial filter includes a Laplacian-Of-Gaussian filter.

4. The apparatus according to claim 1, wherein the spatial filter includes a Difference-Of-Gaussian filter.

5. The apparatus according to claim 1, wherein the spatial filter includes a Separability filter.

6. The apparatus according to claim 1, wherein the spatial filter acquires the filtered image by using a scale parameter with respect to a size of the closed area.

7. The apparatus according to claim 1, wherein the spatial filter acquires a plurality of filtered images by using a plurality of scale parameters with respect to a size of the closed area respectively,
wherein the center estimating unit estimates the center position of the cavity respectively from the plurality of the filtered images, and
wherein the boundary determining unit determines the boundary line based on the plurality of filtered images and the center positions.

8. The apparatus according to claim 1, wherein the spatial filter respectively acquires a plurality of filtered images by using a plurality of scale parameters with respect to a size of the closed area, and
wherein the center estimating unit includes:
a possible center acquiring unit configured to acquire a plurality of possible centers of the cavity portion respectively from the plurality of filtered images,
a scale evaluating unit configured to select a predetermined filtered image whose number of the possible centers is smaller than a threshold value, and
a center determining unit configured to select the center position of the cavity portion from the possible centers of the predetermined filtered image.

9. The apparatus according to claim 8, wherein the boundary determining unit determines the boundary line based on the selected predetermined filtered image and the selected center position.

10. An image processing method comprising:
acquiring an image of an organ having a cavity;
filtering the image by applying a spatial filter to the image, the spatial filter emphasizing a pixel information of the image at a center position of a closed area corresponding to the cavity;
estimating the center position of the cavity from the filtered image; and
determining a boundary line corresponding to a wall of the cavity based on the filtered image and the estimated center position.

11. The method according to claim 10,
wherein, in the filtering step, the spatial filter acquires the filtered image by using a scale parameter with respect to a size of the closed area.

12. The method according to claim 10,
wherein, in the filtering step, the spatial filter acquires a plurality of filtered images by using a plurality of scale parameters with respect to a size of the closed area respectively,
wherein, in the estimating step, the center position of the cavity respectively is estimated from the plurality of the filtered images, and
wherein, in the determining step, the boundary line is determined based on the plurality of filtered images and the center positions.

13. The method according to claim 10,
wherein, in the filtering step, the spatial filter respectively acquires a plurality of filtered images by using a plurality of scale parameters with respect to a size of the closed area, and
wherein the estimating step includes:
acquiring a plurality of possible centers of the cavity portion respectively from the plurality of filtered images,
selecting a predetermined filtered image whose number of the possible centers is smaller than a threshold value, and
selecting the center position of the cavity portion from the possible centers of the predetermined filtered image.
